(19) United States
(12) Patent Application Publication
(10) Pub. No.: US 2021/0304210 A1
(43) Pub. Date: Sep. 30, 2021

(54) INFORMATION PROCESSING METHOD, INFORMATION PROCESSING SYSTEM, AND INFORMATION PROCESSING APPARATUS

(71) Applicant: FUJITSU LIMITED, Kawasaki-shi (JP)

(72) Inventor: Makoto Goda, Warabi (JP)

(73) Assignee: FUJITSU LIMITED, Kawasaki-shi (JP)

(21) Appl. No.: 17/182,478

(22) Filed: Feb. 23, 2021

(30) Foreign Application Priority Data
Mar. 31, 2020 (JP) 2020-064593

(51) Int. Cl. G06Q 20/40; G06Q 20/32

(52) U.S. Cl. CPC G06Q 20/40145; G06Q 20/3227

(57) ABSTRACT

An information processing method that causes a computer to execute a procedure, the procedure includes storing, when first biometric information transmitted from a mobile terminal whose position with respect to the computer satisfy a condition is received, the first biometric information in a memory, specifying, when second biometric information is captured by the computer, first biometric information corresponding to the second biometric information among one or more first biometric information stored in the memory, and transmitting payment information to mobile terminal that is a transmission source of the specified first biometric information.

### CROSS-REFERENCE TO RELATED APPLICATION

This application is based upon and claims the benefit of the prior Japanese Patent Application No. 2020-064593, filed on Mar. 31, 2020, the entire contents of which are incorporated herein by reference.

### FIELD

The embodiments discussed herein are related to an information processing method, an information processing system, and an information processing apparatus.

### BACKGROUND

There has been, for example, a 1:N authentication system in the related art as a biometric authentication system for a majority of users. In the 1:N authentication system, for example, a large amount of user biometric information is retained in a server in advance, biometric information of a user to be authenticated is sequentially collated with the retained biometric information, and the user to be authenticated is authenticated based on an authentication result. As a result, a user may be authenticated, for example, at the time of payment for product purchase in a store or the like.

Related techniques are disclosed in, for example, Japanese Laid-Open Patent Publication No. 2016-062132.

### SUMMARY

According to an aspect of the embodiments, an information processing method that causes a computer to execute a procedure, the procedure includes storing, when first biometric information transmitted from a mobile terminal whose position with respect to the computer satisfy a condition is received, the first biometric information in a memory, specifying, when second biometric information is captured by the computer, first biometric information corresponding to the second biometric information among one or more first biometric information stored in the memory, and transmitting payment information to mobile terminal that is a transmission source of the specified first biometric information.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an explanatory diagram illustrating an example of a payment system according to an embodiment;

FIG. 2 is an explanatory diagram illustrating an example of the arrangement relation of a store in a payment system;

FIG. 3 is a block diagram illustrating an example of the hardware configuration of a smartphone terminal;

FIG. 4 is a block diagram illustrating an example of the functional configuration of the smartphone terminal;

FIG. 5 is a block diagram illustrating an example of the hardware configuration of a payment terminal;

FIG. 6 is a block diagram illustrating an example of the functional configuration of the payment terminal;

FIG. 7 is a sequence diagram illustrating an example of the processing operation of the payment system;

FIG. 8 is a flowchart illustrating an example of the processing operation of a smartphone terminal related to a payment process on the smartphone side;

FIGS. 9A and 98 are flowcharts illustrating an example of the processing operation of a payment terminal related to a payment authentication process; and

FIG. 10 is a block diagram illustrating an example of a computer that executes an information processing program.

### DESCRIPTION OF EMBODIMENTS

In the 1:N authentication system, when the number N of biometric information retained in the server becomes large, the processing load on the server side required for collation increases because the biometric information of a user to be authenticated is sequentially collated (e.g., compared) with all the biometric information retained in the server. Moreover, when the processing load required for collation on the server side becomes large, the collation process takes time.

Hereinafter, embodiments of a technology capable of reducing the processing load required for personal authentication at the time of payment will be described in detail with reference to the drawings. The disclosed technology is not limited by each embodiment. In addition, the embodiments described herein below may be appropriately combined as long as they do not cause a contradiction.

### Embodiments

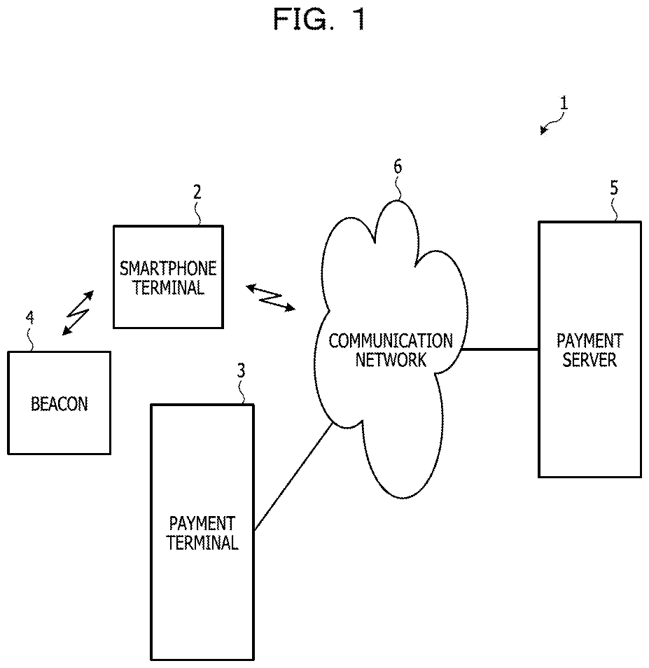

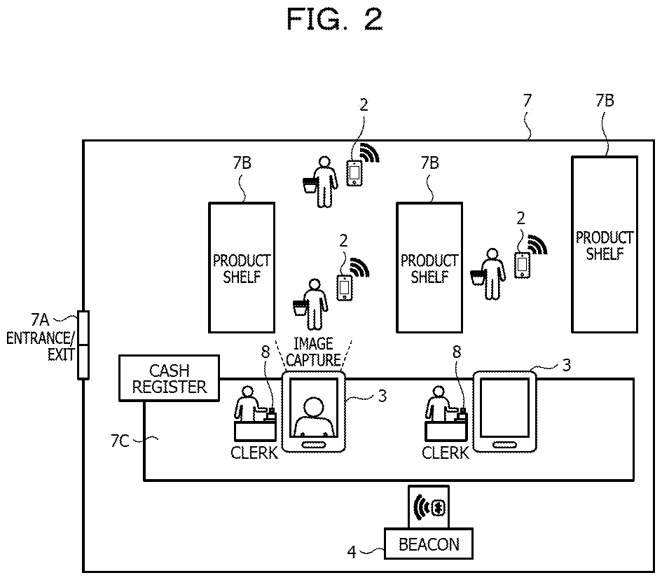

FIG. 1 is an explanatory diagram illustrating an example of a payment system 1 according to an embodiment. The payment system 1 illustrated in FIG. 1 includes a smartphone terminal 2, a payment terminal 3, a beacon 4, a payment server 5, and a communication network 6. The smartphone terminal 2 is, for example, a mobile terminal carried by a user who purchases a product in a store 7 (see, e.g., FIG. 2). In addition, instead of the smartphone terminal 2, for example, a tablet terminal or the like may be used. The payment terminal 3 is, for example, an information processing apparatus used by a clerk at a cash register 7C (see, e.g., FIG. 2) in the store 7. In addition, the payment terminal 3 is, for example, an information processing apparatus such as a personal computer, a tablet terminal, or a smartphone terminal.

The beacon 4 is a signal transmitter that transmits service connection information to the smartphone terminal 2 around the cash register 7C in the store 7 by a short-range wireless communication system such as Bluetooth Low Energy® (BLE). The beacon 4 periodically executes a polling communication to establish a session with the smartphone terminal 2 within a communication range, establishes the session when the smartphone terminal 2 that receives the polling appears, and transmits the service connection information to the smartphone terminal 2. The service connection information is connection information of the payment terminal 3 that provides a payment service within an automatic authenticable range, for example, connection information indicating a connection identification (ID) that enables communication with the payment terminal 3. The automatic authenticable range is an area for providing a payment service in which the payment terminal 3 automatically authenticates a user when the user carrying the smartphone terminal 2 makes a payment for the purchased product, and then makes the payment after the personal authentication. The beacon 4 constantly transmits the service connection information within the short-range wireless communication range around the cash register 7C. Therefore, when a user carrying the smartphone terminal 2 enters the short-range wireless communication range of the beacon 4, the smartphone terminal 2 receives the service connection information from the beacon 4. When the smartphone terminal 2 receives the service connection information from the beacon 4, the smartphone terminal 2 recognizes that the smartphone terminal 2 exists within the automatic authenticable range.

The payment server 5 is, for example, an information processing apparatus such as a server that executes a payment process in a payment service institution. The payment service institution is an institution that pays for goods on behalf of a user. The communication network 6 is, for example, a communication network such as the Internet or a Local Area Network (LAN). For the convenience of descriptions, in the payment system 1 illustrated in FIG. 1, one smartphone terminal 2, one payment terminal 3, and one beacon 4 are illustrated, but the number of smartphone terminals 2, payment terminals 3, and beacons 4 are not limited to one, and may be two or more, and may be changed as appropriate.

FIG. 2 is an explanatory diagram illustrating an example of the arrangement relations of the store 7 in the payment system 1. The store 7 illustrated in FIG. 2 includes an entrance/exit 7A, a plurality of product shelves 7B, and a cash register 7C. The entrance/exit 7A is an entrance/exit of the store 7. The product shelf 7B is a shelf on which a product is placed. The cash register 7C is a space where a user presents a purchased product to a clerk and makes a payment for the purchased product. The cash register 7C includes a plurality of payment terminals 3, a beacon 4, and a Point of Sale (POS) terminal 8. The payment terminals 3 are arranged within a communication range and automatic authenticable range of the beacon 4. The communication range is, for example, 10 m or less but is not limited to 10 m or less and may be changed as appropriate. The POS terminal 8 is disposed at the cash register 7C so that the POS terminal 8 can communicate with the payment terminal 3, inputs information of the purchased product by reading a barcode, calculates the payment amount of the purchased product based on the information of the purchased product, and transmits the payment amount to the payment terminal 3. Further, when the POS terminal 8 receives an instruction to issue a receipt from the payment terminal 3, the POS terminal 8 issues a receipt for the purchased product.

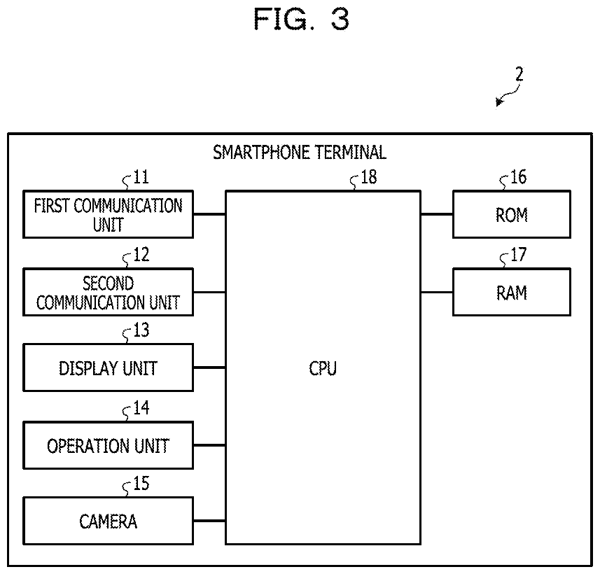

FIG. 3 is a block diagram illustrating an example of the hardware configuration of the smartphone terminal 2. The smartphone terminal 2 illustrated in FIG. 3 includes a first communication unit 11, a second communication unit 12, a display unit 13, an operation unit 14, a camera 15, a Read Only Memory (ROM) 16, a Random Access Memory (RAM) 17, and a Central Processing Unit (CPU) 18. The first communication unit 11 is a communication interface responsible for wireless communication such as 4^{th} Generation (4G), Long Term Evolution (LTE), or 5^{th} Generation 5G). The second communication unit 12 is a communication interface responsible for a short-range wireless communication such as BLE. The display unit 13 is an output interface that displays various types of information. The operation unit 14 is an input interface that inputs various types of information. The camera 15 is an input interface that captures a subject such as, for example, a facial image of a user.

The ROM 16 is an area where various programs and the like are stored. The RAM 17 is an area where various types of information are stored. The CPU 18 controls the entire smartphone terminal 2. The CPU 18 deploys a program stored in the ROM 16 on a work area on the RAM 17, and executes the program on the RAM 17 as a process function.

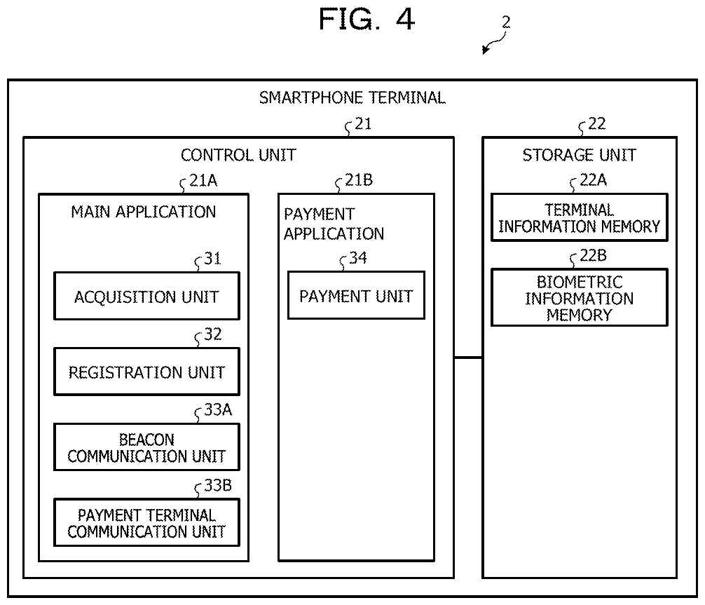

FIG. 4 is a block diagram illustrating an example of the functional configuration of the smartphone terminal 2. The smartphone terminal 2 illustrated in FIG. 4 includes a control unit 21 and a storage unit 22 as process functions. The control unit 21 executes a main application 21A and a payment application 21B. The main application 21A is an application that executes various processes of the smartphone terminal 2. The main application 21A includes an acquisition unit 31, a registration unit 32, a beacon communication unit 33A, and a payment terminal communication unit 33B as functions. The payment application 21B is an application used at the time of payment of the smartphone terminal 2. The payment application 21B includes a payment unit 34 as a function.

The storage unit 22 includes a terminal information memory 22A and a biometric information memory 22B. The terminal information memory 22A stores terminal information such as a terminal ID that identifies the smartphone terminal 2. The biometric information memory 22B stores biometric information used for registered collation of a user of the smartphone terminal 2, for example, the feature amount of a facial image. The user's biometric information stored in the biometric information memory 22B is biometric information used for the user's personal authentication. The user's biometric information stored in the biometric information memory 22B is determined by an entity who permits a service used by a user. For example, when a user uses a service for paying for a purchased product, the biometric information is biometric information of the user who permits the use of the service.

The beacon communication unit 33A communicates with the beacon 4. The payment terminal communication unit 33B communicates with the payment terminal 3. When the service connection information is received from the beacon 4 through the beacon communication unit 33A, for example, when a condition on a position of the payment terminal 3 is satisfied, the acquisition unit 31 acquires the terminal ID stored in the terminal information memory 22A and the biometric information stored in the biometric information memory 22B. That is, when the smartphone terminal 2 is placed within the automatic authenticable range, the acquisition unit 31 acquires the terminal ID stored in the terminal information memory 22A and the biometric information stored in the biometric information memory 22B. The payment terminal communication unit 33B transmits the acquired terminal ID and biometric information to the payment terminal 3 through the second communication unit 12. That is, only the smartphone terminal 2 placed within the automatic authenticable range transmits the biometric information and the terminal ID to the payment terminal 3.

The registration unit 32 registers, for example, biometric information such as a user's facial image captured by the camera 15 in the biometric information memory 22B. When payment information is received from the payment terminal 3 through the payment terminal communication unit 33B, the payment unit 34 generates payment data from the payment information based on the payment amount of the purchased product and store information. The payment information is the payment amount of the purchased product and store information after personal authentication using the user's biometric information by the payment terminal 3. Further, the payment terminal communication unit 33B transmits the generated payment data to the payment server 5 via the communication network 6. The payment data are the payment amount of the purchased product, the store information, the user ID of a user, and the like.

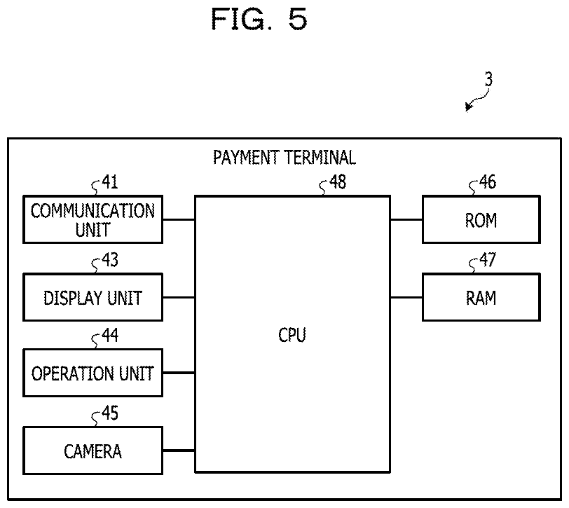

FIG. 5 is a block diagram illustrating an example of the hardware configuration of the payment terminal 3. The payment terminal 3 illustrated in FIG. 5 includes a communication unit 41, a display unit 43, an operation unit 44, a camera 45, a ROM 46, a RAM 47, and a CPU 48. The communication unit 41 is a communication interface for wired or wireless communication with the communication network 6. The display unit 43 is an output interface that displays various types of information. The operation unit 44 is an input interface that input various types of information. The camera 45 is an input interface that captures a facial image of a subject, for example, a user.

The ROM 46 is an area where various programs and the like are stored. The RAM 47 is an area where various types of information are stored. The CPU 48 controls the entire payment terminal 3. It is assumed that a program that implements a process in the smartphone terminal 2 is stored in, for example, the ROM 46 or the like. The CPU 48 deploys the program stored in the ROM 46 on the RAM 47, and executes process functions that correspond to the various programs on the RAM 47.

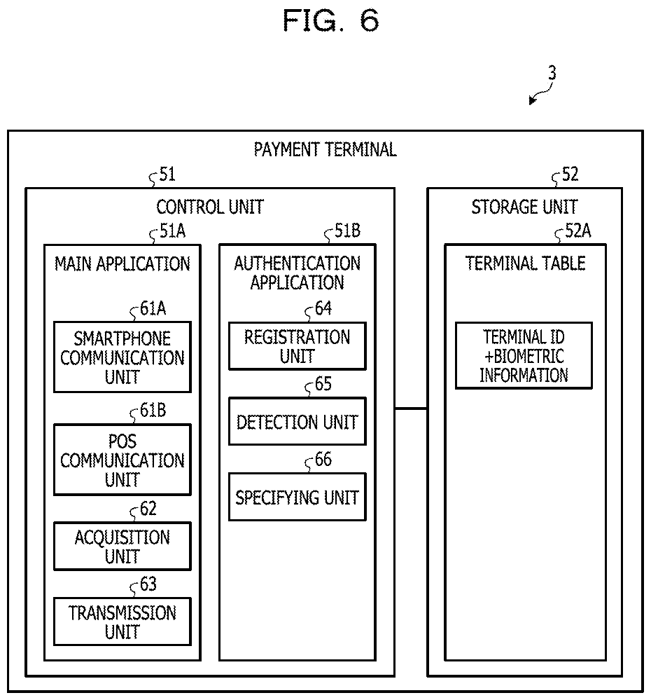

FIG. 6 is a block diagram illustrating an example of the functional configuration of the payment terminal 3. The payment terminal 3 illustrated in FIG. 6 includes a control unit 51 and a storage unit 52 as process functions. The control unit 51 executes a main application 51A and an authentication application 51B. The main application 51A is an application that links with the POS terminal 8 that manages the products in the store 7 and controls the entire payment terminal 3. The main application 51A includes a smartphone communication unit 61A, a POS communication unit 61B, an acquisition unit 62, and a transmission unit 63 as functions.

The smartphone communication unit 61A communicates with the smartphone terminal 2. The POS communication unit 61B communicates with the POS terminal 8. The POS terminal 61B receives a payment notification including the payment amount of the purchased product of a user from the POS terminal 8. The acquisition unit 62 acquires the payment amount from the payment notification and generates payment information including the payment amount of the purchased product. The payment information is the payment amount of the purchased product and the store information. The transmission unit 63 transmits various types of information such as the payment information to the smartphone terminal 2 through the smartphone communication unit 61.

The authentication application 51B is an application for authenticating a user when the user makes a payment for a product. The authentication application 51B includes a registration unit 64, a detection unit 65, and a specifying unit 66 as functions. The registration unit 64 registers the terminal ID and the biometric information received from the smartphone terminal 2 in association with each other in a terminal table 52A which is a storage unit. The payment terminal 3 registers in the terminal table 52A only the terminal ID and biometric information of the smartphone terminal 2 placed within the automatic authenticable range.

The detection unit 65 captures a facial image of the authentication target of a product purchaser with the camera 45 and detects biometric information such as the captured facial image of the authentication target. When the biometric information detected by the detection unit 65 is received, the specifying unit 66 specifies biometric information corresponding to the received biometric information among one or more biometric information registered in the terminal table 52A. When the biometric information corresponding to the received biometric information is specified, the specifying unit 66 determines that the authentication result is OK, in which the collation of the biometric information matches and the personal authentication is successful. Further, when the biometric information is specified, that is, when the authentication result is OK, the specifying unit 66 specifies a terminal ID corresponding to the specified biometric information from the terminal table 52A, and specifies the smartphone terminal 2 which is a transmission source of the specified biometric information, based on the specified terminal ID. Further, the transmission unit 63 transmits payment information to the smartphone terminal 2 which is the transmission source of the specified biometric information among one or more smartphone terminals 2 through the smartphone communication unit 61.

The payment terminal 3 registers in the terminal table 52A only the biometric information of the user of the smartphone terminal 2 who has entered the authenticable range near the cash register 7C. As a result, the processing load required for authentication may be significantly reduced by significantly reducing the number of populations to be authenticated, as compared with the conventional 1:N authentication system in which an unspecified number of biometric information is stored in the server. Further, when there are a plurality of people within the automatic authenticable range, the terminal ID and the biometric information are transferred from smartphone terminals 2 carried by all the people to the payment terminal 3. As a result, it means that a population, which is an authentication target, is created (information on a target person who may be authenticated is collected in advance on the spot) based on the relative positional relationship (automatic authenticable range) or distance (in this case, a range of the radio wave of the beacon 4) between a place (the cash register 7C in this case) where the service is provided and a user.

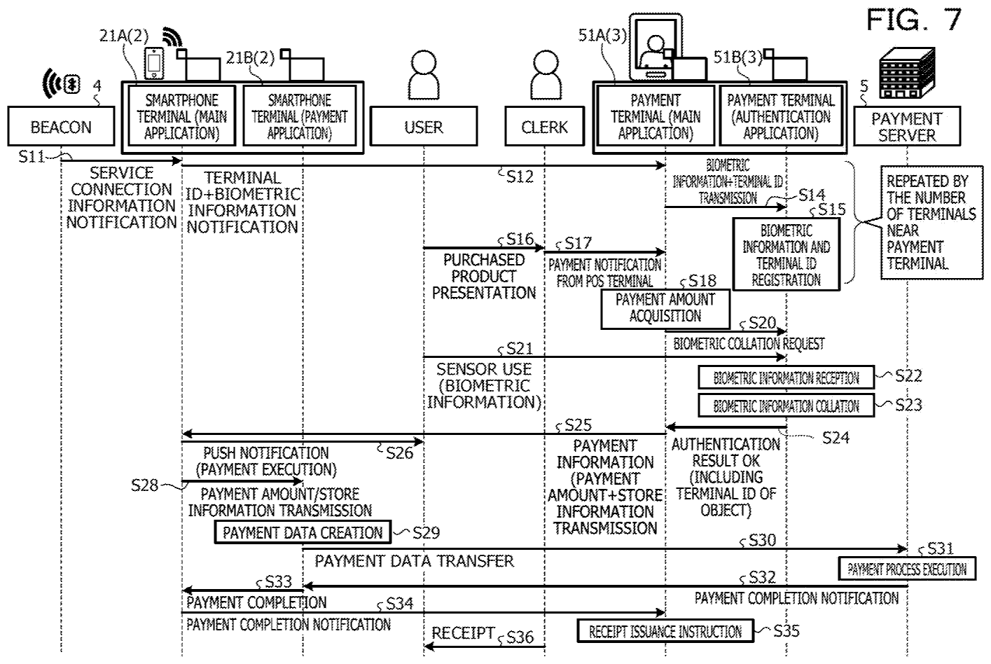

FIG. 7 is a sequence diagram illustrating an example of the processing operation of the payment system 1. For example, it is assumed that a user carrying the smartphone terminal 2 enters the store 7 to purchase a product, takes the product, and approaches the cash register 7C. In addition, it is assumed that the user acquires his/her own biometric information with the camera 15 in the smartphone terminal 2 and registers the acquired biometric information in the biometric information memory 22B in advance.

The beacon communication unit 33A in the main application 21A of the smartphone terminal 2 illustrated in FIG. 7 receives the service connection information from the beacon 4 through the second communication unit 12, and reads out the terminal ID stored in the terminal information memory 22A and the biometric information stored in the biometric information memory 22B (operation S11). The payment terminal communication unit 33B in the main application 21A transmits the read terminal ID and biometric information to the payment terminal 3 (operation S12).

The main application 51A in the payment terminal 3 receives the terminal ID and the biometric information and transfers the terminal ID and the biometric information to the authentication application 51B in the payment terminal 3 (operation S14). Further, the authentication application 51B registers the terminal ID and the biometric information in the terminal table 52A in association (operation S15). When the terminal ID and the biometric information are received from each user's smartphone terminal 2 through the smartphone communication unit 61A, the payment terminal 3 sequentially registers the biometric information in the terminal table 52A for each terminal ID. That is, the payment terminal 3 registers only the terminal ID and the biometric information of the smartphone terminal 2 placed in the automatic authenticable range in the terminal table 52A.

When the clerk of the cash register 7C is presented with the purchased products by the user (operation S16), the POS terminal 8 reads out the purchased product, calculates the total amount of the purchased products, checks a payment method of the purchased products for the user, and when the payment method is a biometric authentication payment, transmits a payment notification including the payment amount to the payment terminal 3 through the POS terminal 8 (operation S17). An operation for selecting the payment method is, for example, a button operation of the POS terminal 8 for selecting biometric authentication payment, QR Code® payment, credit card payment, or cash payment. The main application 51A in the payment terminal 3 acquires the payment amount of the purchased products from the payment notification from the POS terminal 8 (operation S18). When the payment amount is acquired, the main application 51A requests the authentication application 51B for a biometric collation request (operation S20). Further, the camera 45 of the payment terminal 3 acquires the biometric information of the user who is the purchaser of the products (operation S21). Then, the authentication application 51B of the payment terminal 3 receives the acquired biometric information of the user (operation S22).

The authentication application 51B collates the biometric information received in the operation S22 with the biometric information in the terminal table 52A (operation S23). Since the number of biometric information in the terminal table 52A is the number of smartphone terminals 2 of users who have received the service connection information of the beacon 4 currently placed in the automatic authenticable range near the cash register 7C, the number of collations of biometric information is limited as compared with the number of collations of biometric information of the conventional 1:N authentication system.

When the authentication result is OK, the authentication application 51B transmits the authentication result OK including the terminal ID that identifies the smartphone terminal 3 whose authentication result is OK, to the main application 51A in the payment terminal 3 (operation S24). The main application 51A receives the authentication result OK, generates payment information including the payment amount of the purchased products and store information based on the terminal ID in the authentication result OK, and transmits the payment information to the main application 21A in the smartphone terminal 2 (operation S25).

The main application 21A notifies the user of payment execution according to the payment information (operation S26). The smartphone terminal 2 notifies the user of the payment execution by sound, vibration or the like according to the payment information. The user of the smartphone terminal 2 may recognize that the authentication result is OK, that is, the personal authentication is successful, by sound, vibration, or the like.

The main application 21A of the smartphone terminal 2 receives the payment information from the payment terminal 3, and transfers the payment amount of the purchased product and the store information in the payment information to the payment application 21B in the smartphone terminal 2 (operation S28). The payment application 21B generates payment data including the payment amount of the purchased product, the store information, and the user ID in the payment information (operation S29). The payment application 21B transmits the payment data to the payment server 5 of the payment service institution through the first communication unit 11 (operation S30).

The payment server 5 of the payment service institution receives the payment data from the smartphone terminal 2, executes a payment process for paying the payment amount of the purchased product of the payment data (operation S31), and transmits a payment completion notification to the smartphone terminal 2 (operation S32).

The payment application 21B of the smartphone terminal 2 receives the payment completion notification, and notifies the main application 21A of the payment completion (operation S33). The payment terminal communication unit 33B in the main application 21A of the smartphone terminal 2 receives the payment completion, and transmits the payment completion notification to the payment terminal 3 through the second communication unit 12 (operation S34). Then, the POS communication unit 61B in the payment terminal 3 receives the payment completion notification of the purchased product, and transmits to the POS terminal 8 an instruction to issue a payment completion receipt of the purchased product (operation S35). The POS terminal 8 prints and outputs the receipt in response to the instruction to issue the receipt. Then, the clerk hands the receipt printed and output by the POS terminal 8 to the user (operation S36), so that the product purchase is completed. As a result, the user may visually recognize the contents of the receipt and recognize the completion of payment of the purchased product. Although a case where the payment server 5 executes the payment process in the operation S31 and then transmits the payment completion notification to the smartphone terminal 2, the payment completion notification may be transmitted to the payment terminal 3. In this case, the payment terminal 3 may present the receipt to the user in response to the payment completion notification from the payment server 5, and may be changed as appropriate.

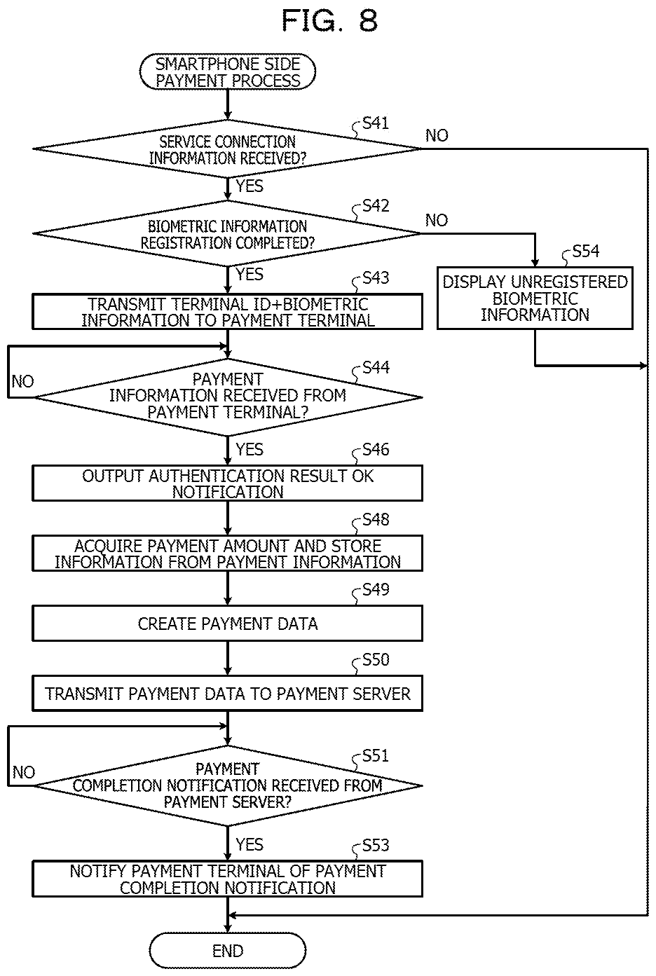

FIG. 8 is a flowchart illustrating an example of the processing operation of the smartphone terminal 2 related to the payment process on the smartphone side. In FIG. 8, the beacon communication unit 33A in the smartphone terminal 2 determines whether or not the service connection information from the beacon 4 has been received (operation S41). When it is determined that the service connection information from the beacon 4 has been received (Yes in operation S41), the acquisition unit 31 in the smartphone terminal 2 refers to the biometric information memory 22B to determine whether or not its own biometric information has been registered (operation S42).

When it is determined that the biometric information has been registered (Yes in operation S42), the payment terminal communication unit 33B transmits to the payment terminal 3 the terminal ID being stored in the terminal information memory 22A and the biometric information completed to be registered in the biometric information memory 22B, based on the connection ID in the service connection information (operation S43). The payment unit 34 in the smartphone terminal 2 determines whether or not the payment information has been received from the payment terminal 3 through the payment terminal communication unit 33B (operation S44).

When it is determined that the payment information has been received (Yes in operation S44), the payment unit 34 notifies the user of the authentication result OK (operation S46). The user may recognize the authentication result OK, that is, the success of the personal authentication, with the notification.

The payment unit 34 acquires the payment amount of the purchased product, the store information, and the like from the payment information (operation S48).

The payment unit 34 generates payment data including the payment amount of the purchased product, the store information, the user ID, etc. (operation S49), and transmits the payment data to the payment server 5 of the payment service institution (operation S50). The payment server 5 executes payment for the purchased product on behalf of the user based on the payment data. The payment unit 34 determines whether or not a payment completion notification has been received from the payment server 5 (operation S51).

When it is determined that the payment completion notification has been received (Yes in operation S51), the payment unit 34 notifies the payment terminal 3 of a payment completion notification through the payment terminal communication unit 33B (operation S53), and ends the processing operation illustrated in FIG. 8. It is assumed that the payment completion notification is a notification indicating that the payment has been completed normally. However, when the payment completion notification is, for example, a payment NG notification indicating that the payment has not been performed normally, the payment unit 34 may proceed to the operation S53 in order to notify the payment terminal 3 of the payment NG, and may also be changed as appropriate.

When it is determined that the service connection information has not been received (No in operation S41), the smartphone terminal 2 ends the processing operation illustrated in FIG. 8. When it is determined that the biometric information has not been registered in the biometric information memory 22B (No in operation S42), the main application 21A in the smartphone terminal 2 displays the unregistered biometric information on the display unit 13 (operation S54), and ends the processing operation illustrated in FIG. 8. The user may visually recognize the display contents of the display unit 13, and recognize that the biometric information has not been registered.

When it is determined that the payment information has not been received from the payment terminal 3 (No in operation S44), the payment unit 34 proceeds to the operation S44 in order to determine whether or not the payment information has been received.

When it is determined that the payment completion notification has not been received from the payment server 5 (No in operation S51), the payment unit 34 proceeds to the operation S51 in order to determine whether or not the payment completion notification has been received.

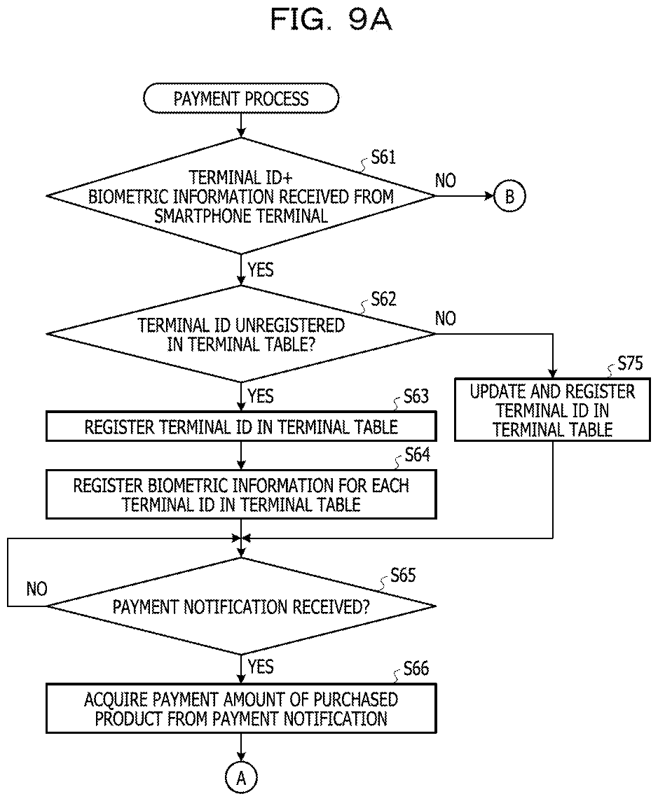

FIG. 9 is a flowchart illustrating an example of the processing operation of the payment terminal 3 related to the payment authentication process. In FIG. 9, the main application 51A in the payment terminal 3 determines whether or not a terminal ID and biometric information have been received from the smartphone terminal 2 through the smartphone communication unit 61A (operation S61). When it is determined that the terminal ID and the biometric information have been received (Yes in operation S61), the authentication application 51B in the payment terminal 3 determines whether or not the corresponding terminal ID is unregistered in the terminal table 52A (operation S62).

When it is determined that the corresponding terminal ID is unregistered (Yes in operation S62), the registration unit 64 in the authentication application 51B registers the corresponding terminal ID received in the operation S61 in the terminal table 52A (operation S63). Further, the registration unit 64 registers the biometric information received in the operation S61 in association with the corresponding terminal ID in the terminal table 52A (operation S64). That is, the payment terminal 3 pre-registers only the biometric information and the terminal ID of the smartphone terminal 2 placed within the automatic authenticable range.

The POS communication unit 61B in the payment terminal 3 determines whether or not a payment notification has been received from the POS terminal 8 (operation S65). When it is determined that the payment notification has been received from the POS terminal 8 (Yes in operation S65), the acquisition unit 62 in the payment terminal 3 acquires the payment amount of the purchased product from the payment notification (operation S66). The detection unit 65 in the payment terminal 3 acquires the payment amount of the purchased product and determines whether or not the biometric information of a user who is a product purchaser has been received through the camera 45 (operation S67).

When it is determined that the biometric information of the user has been received (Yes in operation S67), the specifying unit 66 in the payment terminal 3 collates the received biometric information with the biometric information registered in the terminal table 52A (operation S68). When the received biometric information can be specified from the registered biometric information, the specifying unit 66 determines whether or not the authentication result is OK, that is, the personal authentication is successful (operation S69).

When it is determined that the authentication result is OK (Yes in operation S69), the specifying unit 66 specifies a terminal ID of the authentication result OK from the terminal table 52A (operation S70). After the terminal ID of the authentication result OK is specified, the transmission unit 63 in the payment terminal 3 transmits the authentication result OK to the smartphone terminal 2 through the smartphone communication unit 61A based on the specified terminal ID (operation S71). Further, the transmission unit 63 transmits payment information including the payment amount of the purchased product and the store information to the smartphone terminal 2 through the smartphone communication unit 61A based on the specified terminal ID (operation S72).

The main application 51A in the payment terminal 3 determines whether or not a payment completion notification has been received from the smartphone terminal 2 (operation S73). When it is determined that the payment completion notification has been received (Yes in operation S73), the POS communication unit 618 in the main application 51A transmits to the POS terminal 8 a receipt issuing instruction to print out a receipt of the purchased product (operation S74), and ends the processing operation illustrated in FIG. 9.

When it is determined that the terminal ID and the biometric information have not been received from the smartphone terminal 2 (No in operation S61), the payment terminal 3 ends the processing operation illustrated in FIG. 9. When it is determined that the corresponding terminal ID is not unregistered in the terminal table 52A (No in operation S62), that is, when the corresponding terminal ID is already registered, the registration unit 64 updates and registers the terminal ID in the terminal table 52A (operation S75). Then, the operation proceeds to the operation S65 in order to determine whether or not the payment notification has been received. When it is determined that the payment notification has not been received (No in operation S65), the payment terminal 3 proceeds to the operation S65 in order to determine whether or not the payment notification has been received. When it is determined that the biometric information of the user has not been received (No in operation S67), the payment terminal 3 proceeds to the operation S67 in order to determine whether or not the biometric information of the user has been received.

When it is determined that the authentication result is not OK (No in operation S69), that is, when the authentication result is NG, the main application 51A notifies the clerk of the authentication result NG (operation S76), and proceeds to the operation S67 in order to determine whether or not the biometric information of the user has been received. The clerk recognizes the failure of the personal authentication of the product purchaser according to the notification of the authentication result NG. Then, for example, the clerk urges the product purchaser to perform an operation of acquiring the biometric information again.

When it is determined that the payment completion notification has not been received from the smartphone terminal 2 (No in operation S73), the main application 51A proceeds to the operation S73 in order to determine whether or not the payment completion notification has been received.

When one or more biometric information transmitted respectively from one or more smartphone terminals 2 whose position with respect to the payment terminal 3 satisfies a condition are received, the payment terminal 3 of the present embodiment stores the received one or more biometric information in the terminal table 52A. When detected biometric information is received, the payment terminal 3 specifies biometric information corresponding to the received biometric information among the one or more biometric information stored in the terminal table 52A. The payment terminal 3 transmits payment information to the smartphone terminal 2 that is a transmission source of the specified biometric information among the one or more smartphone terminals 2. As a result, the processing burden of personal authentication at the time of payment can be reduced.

When the terminal ID that identifies the smartphone terminal 2 is received in addition to the biometric information transmitted from the smartphone terminal 2, the payment terminal 3 stores the received biometric information and terminal ID in the terminal table 52A in association with each other. The payment terminal 3 transmits the payment information to the smartphone terminal 2 that is the transmission source of the specified biometric information among the one or more smartphone terminals 2, based on the terminal ID corresponding to the specified biometric information. As a result, the payment information may be transmitted to the transmission source smartphone terminal 2 using the terminal ID.

In the present embodiment, among an unspecified number of users, product purchasers of smartphone terminals 2 placed within a communication range of the beacon 4, that is, within the automatic authenticable range around the payment terminal 3, are targeted for authentication, and therefore, the number of biometric information of the population to be authenticated can be significantly limited. As a result, the processing load required for authentication and management can be significantly reduced. Moreover, it is possible to realize the authentication and management at low costs (suppression of service provision or management cost per ID) and substantial elimination of the upper limit of the number of registered data.

In the 1:N authentication system of the related art, a database that centrally manages a large amount of biometric information is provided, and when the number of biometric information held in the database exceeds a certain number of populations, the processing load when collating with the biometric information to be authenticated increases. In contrast, in the present embodiment, since the biometric information of the smartphone terminal 2 of the user who enters the authenticable range near the payment terminal 3 is acquired and the acquired biometric information and the biometric information of the product purchaser are only collated, the processing load required for the collation process can be significantly reduced. Further, since the number of biometric information held in the payment terminal 3 is small, not only the burden of managing the biometric information may be significantly reduced, and but also, even when the biometric information of the payment terminal is leaked, the influence of the information leakage may be minimized.

In addition, in a case where the present embodiment is used for individual identification (membership and non-member identifications) when a user visits a store, it is possible to easily implement an unmanned store.

In the payment system 1 of the embodiment, when the beacon 4 in the vicinity of the payment terminal 3 transmits the service connection information and the smartphone terminal 2 which enters the communication range of the beacon 4 receives the service connection information from the beacon 4, a case where the biometric information and the terminal ID are transmitted from the smartphone terminal 2 to the payment terminal 3 has been illustrated. However, without being limited to the beacon 4, the smartphone terminal 2 may transmit only the biometric information when the service connection information is simply received. Further, a case where the beacon 4 is disposed in the vicinity of the payment terminal 3 has been illustrated, but instead of the beacon 4, the payment terminal 3 itself may periodically transmit the service connection information, and may be changed as appropriate. Further, the payment terminal 3 may have the beacon 4.

Further, a case where the beacon 4 transmits the service connection information in the automatic authenticable range to the smartphone terminal 2 of the user who enters the communication range of the beacon 4 has been illustrated. However, the beacon 4 may transmit position information of the store that uses the payment terminal 3 or position information that identifies the location of the payment terminal 3 in the store, and may be changed as appropriate.

Further, a case has been illustrated where the smartphone terminal 2 determines that the user is placed within the automatic authenticable range and transmits the biometric information and the terminal ID to the payment terminal 3 when the smartphone terminal 2 receives the service connection information from the beacon 4. However, the smartphone terminal 2 is not limited to receiving the service connection information from the beacon 4, and may be changed as appropriate. Instead of the beacon 4, for example, the service connection information may be notified from a Wireless Fidelity (WiFi) positioning function, a Radio Frequency Identification (RFID) positioning function, a Global Positioning System (GPS) positioning function, a pedestrian self-contained navigation positioning function, or the like. Further, instead of the beacon 4, for example, the service connection information may be notified from a geomagnetic positioning function, a sound wave positioning function, a visible light positioning function, an Indoor MEssaging System (IMES) positioning function, an Ultra-Wide Band (UWB) positioning function, or the like. Further, even when the smartphone terminal 2 does not have a positioning function, the smartphone terminal 2 may transmit the biometric information and the terminal ID to the payment terminal 3 by a user's operation when the user of the smartphone terminal 2 enters the automatic authenticable range, and may be changed as appropriate.

For the WiFi positioning, a WiFi base station may be utilized to specify the position of the smartphone terminal 2. The base station manages the connection ID of the payment terminal 3 for each communicable area position, recognizes the area position of the smartphone terminal 2 by regular communication with the smartphone terminal 2, acquires a connection ID according to the area position, and notifies the smartphone terminal 2 of the service connection information including the connection ID. Further, when the base station recognizes that the smartphone terminal 2 is placed within the automatic authenticable range, the service connection information may be transmitted from the payment terminal 3 to the smartphone terminal 2 according to an instruction from the base station, and can be changed as appropriate.

For the GPS positioning, the smartphone terminal 2 holds the automatic authenticable range, and manages the connection ID of the payment terminal 3 for each position. When it is recognized from the current position measured by the GPS of the smartphone terminal 2 that the smartphone terminal 2 is placed within the automatic authenticable range, the smartphone terminal 2 specifies a connection ID corresponding to the current position, and the biometric information and the terminal ID may be transmitted to the payment terminal 3 based on the specified connection ID.

In addition, areas may be provided for longitude and latitude at regular intervals, and each time a user who carries the smartphone terminal 2 moves over a set area in the areas, the smartphone terminal 2 may be notified from a server or the like that manages information of the payment terminal 3 in the target area. Further, the service connection information may be transmitted from the payment terminal 3 to the smartphone terminal 2, and may be changed as appropriate. Further, the payment terminal 3 may request the biometric information from the smartphone terminal 2 that enters its own automatic authenticable range, and can be changed as appropriate.

A case where the beacon 4 transmits the service connection information including the connection ID that identifies the payment terminal 3 to the smartphone terminal 2 that enters the automatic authenticable range has been illustrated. However, an information notification server that manages the service connection information including the connection ID of the payment terminal 3 may be separately provided for each beacon ID that identifies the beacon 4.

In this case, the beacon 4 transmits the beacon ID, instead of the service connection information, to the smartphone terminal 2 that enters the automatic authenticable range. The smartphone terminal 2 notifies the information notification server of a search request including the beacon ID. Then, when the search request is received, the information notification server transmits the service connection information corresponding to the beacon ID in the search request to the smartphone terminal 2. As a result, the smartphone terminal 2 may transmit the biometric information and the terminal ID to the payment terminal 3 based on the connection ID in the service connection information received from the information notification server. In this case, even when a malicious third party illegally installs the beacon 4 to attempt to illegally obtain the biometric information, since the biometric information is transmitted only to the payment terminal 3 already registered in the information notification server, it is possible to prevent illegal acquisition of the biometric information by the third party.

A case where the payment terminal 3 registers the biometric information received from the smartphone terminal 2 in the terminal table 52A has been illustrated. However, the terminal ID and the biometric information of the smartphone terminal 2 may be registered or updated in the terminal table 52A, then a timer may be started to count, and the terminal ID and the biometric information may be deleted from the terminal table 52A after a predetermined time has elapsed. In this case, it is possible to avoid a situation in which the biometric information and the terminal ID remain in the payment terminal 3.

Further, after the biometric information received from the smartphone terminal 2 is registered in the terminal table 52A, when for example, the payment completion notification indicating that the payment of the product is completed is received from the smartphone terminal 2, the payment terminal 3 may delete the biometric information and the terminal ID of the corresponding user from the terminal table 52A. In this case, it is possible to avoid a situation in which the biometric information and the terminal ID remain in the payment terminal 3.

Further, when the smartphone terminal 2 leaves the automatic authenticable range, the payment terminal 3 may delete the terminal ID and the biometric information of the smartphone terminal 2 from the terminal table 52A. In this case, it is possible to avoid a situation in which the biometric information and the terminal ID remain in the payment terminal 3.

Further, the biometric information has been exemplified with the feature amount of the user's facial image, but it is not limited to the feature amount of the facial image and may be any biometric information as long as the biometric information can authenticate an individual user, for example, biometric information such as fingerprints, veins, irises, and the like of the user. When the biometric information is used as the fingerprints, the smartphone terminal 2 and the payment terminal 3 are provided with a fingerprint reading unit that reads the user's fingerprints. Further, when the biometric information is used as the veins, the smartphone terminal 2 and the payment terminal 3 are provided with a vein reading unit that reads the user's veins. Further, when the biometric information is used as the irises of the user, the smartphone terminal 2 and the payment terminal 3 are provided with an iris reading unit that reads the irises of the user. Further, a case where the camera 15 of the smartphone terminal 2 captures the facial image of the user in order to register the biometric information has been illustrated, but the case is not limited to the camera 15 of the smartphone terminal 2. For example, another device (biometric data registration device) different from the smartphone terminal 2, or a camera existing on a network may capture the facial image of the user, and may be changed as appropriate.

A case where the smartphone terminal 2 transmits the biometric information and the terminal ID to the payment terminal 3 according to the service connection information has been illustrated. However, the biometric information and the terminal ID from the smartphone terminal 2 may be encrypted, and the encrypted biometric information and terminal ID may be transmitted to the payment terminal 3. As a result, the security level of the biometric information and the terminal ID from the smartphone terminal 2 to the payment terminal 3 is improved.

When the service connection information is received from the beacon 4, the smartphone terminal 2 may generate a one-time ID that identifies the smartphone terminal 2, which is used only while staying within the radio wave reception range of the beacon 4, and, instead of the terminal ID, may transmit the one-time ID and the biometric information to the payment terminal 3. For example, when the service connection information of the payment terminal 3 is received from the beacon 4, the smartphone terminal 2 transmits the connection ID of the payment terminal 3 and its own terminal ID and biometric information to a server. The server converts the terminal ID from the requested smartphone terminal 2 into a one-time ID valid only for the session for the payment terminal 3 of the connection ID, and transmits the one-time ID and the biometric information to the payment terminal 3. The server manages the terminal ID and the one-time ID and does not hold the biometric information. The payment terminal 3 cannot specify the smartphone terminal 2 from the one-time ID and the biometric information. Therefore, even when the biometric information is obtained with an evil intent, the biometric information may not be used for other authentication. Further, since the biometric information does not remain in the server, the information of combination of the terminal ID and the biometric information exists only in the smartphone terminal 2, thereby maintaining the security.

While descriptions have been made on a case where the present embodiment is applied to the product payment in a store, the present embodiment may also be applied to, for example, entrance/exit (reception) sensors/doors and gates, lockers, vending machines, and the like.

Further, each component of each unit illustrated in the drawings is not necessarily required to be physically configured as illustrated. That is, specific forms of distribution or integration of the respective units is not limited to those illustrated, and all or a portion of the units may be configured to be functionally or physically distributed or integrated in arbitrary units according to, for example, various loads or usage conditions.

Furthermore, all or an arbitrary portion of the various processing functions performed by each device may be executed on a Central Processing Unit (CPU), a Digital Signal Processor (DSP), a Field Programmable Gate Array (FPGA), etc. Further, all or an arbitrary portion of the various processing functions may be executed on a program to be analyzed and executed by the CPU or the like, or on hardware by wired logic.

An area for storing various types of information may be configured with, for example, a ROM or a RAM such as a Synchronous Dynamic Random Access Memory (SDMAM), a Magnetoresistive Random Access Memory (MRAM), a Non-Volatile Random Access Memory (NVRAM), or the like.

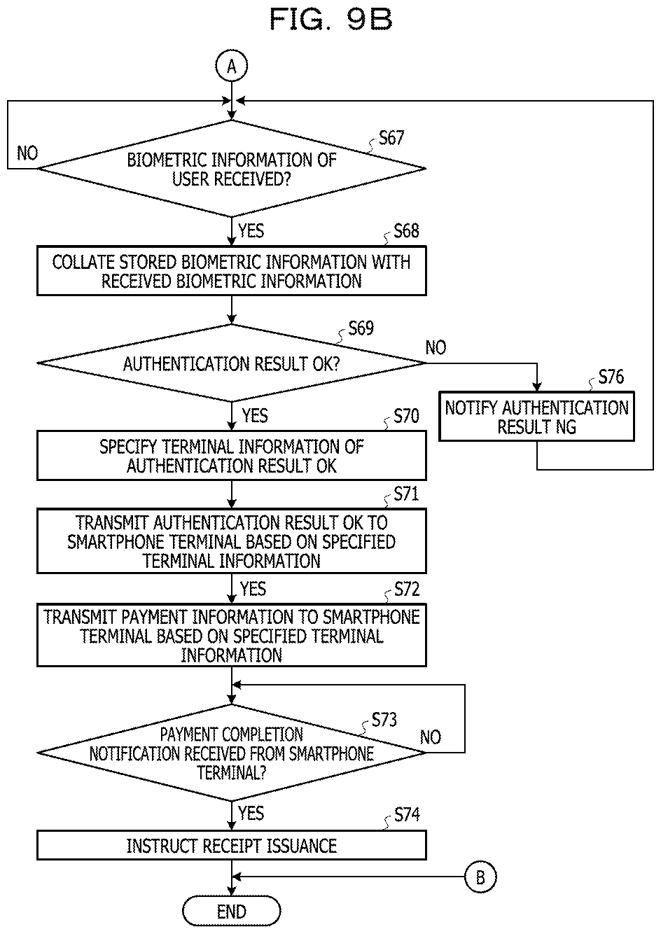

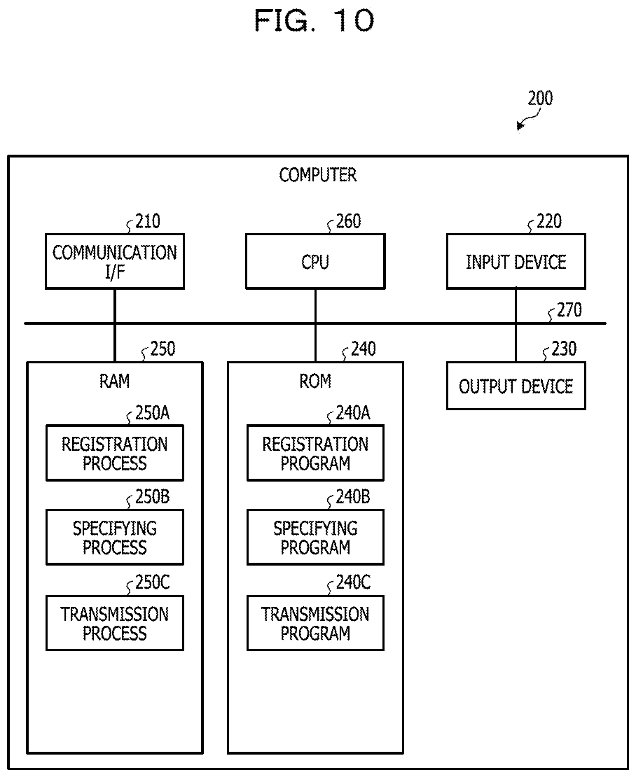

Incidentally, various processes described in the present embodiment may be implemented by executing a program prepared in advance by a processor such as a CPU in a computer. Therefore, an example of a computer that executes a program having the same function as that of the above-described embodiment will be described below. FIG. 10 is a block diagram illustrating an example of a computer that executes an information processing program.

The computer 200 that executes the information processing program illustrated in FIG. 10 includes a communication Interface (IF) 210, an input device 220, an output device 230, a ROM 240, a RAM 250, and a CPU 260. The communication IF 210, the input device 220, the output device 230, the ROM 240, the RAM 250, and the CPU 260 are connected via a bus 270. The communication IF 210 is an input/output interface that communicates with a user's mobile terminal. The computer 200 is, for example, a payment terminal that requests payment of a user's purchased product. The input device 220 is, for example, a detection unit that detects biometric information.

Then, the ROM 240 stores in advance information processing programs that exhibit the same functions as those of the above-described embodiment. The ROM 240 stores a registration program 240A, a specifying program 240B, and a transmission program 240C as the information processing programs. A control program may be recorded on a recording medium computer-readable with a drive (not shown) instead of the ROM 240. The recording medium may be, for example, a portable recording medium such as a CD-ROM, a DVD disc, or a USB memory, or a semiconductor memory such as a flash memory.

Then, the CPU 260 reads the registration program 240A from the ROM 240, and functions as a registration process 250A on the RAM 250. Further, the CPU 260 reads the specifying program 240B from the ROM 240, and functions as a specifying process 250B on the RAM 250. Further, the CPU 260 reads the transmission program 240C from the ROM 240, and functions as a transmission process 250C on the RAM 250.

When one or more biometric information transmitted from one or more mobile terminals whose positions with respect to the computer 200 satisfy a condition are received, the CPU 260 stores the received one or more biometric information in the RAM 250. When the biometric information detected by a detection unit is received, the CPU 260 specifies biometric information corresponding to the received biometric information among the one or more biometric information stored in the RAM 250. The CPU 260 transmits payment information to a mobile terminal, which is the transmission source of the specified biometric information, among the one or more mobile terminals. As a result, the processing load at the time of payment can be reduced.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to an illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing method that causes a computer to execute a procedure, the procedure comprising:
storing, when first biometric information transmitted from a mobile terminal whose position with respect to the computer satisfy a condition is received, the first biometric information in a memory;
specifying, when second biometric information is captured by the computer, first biometric information corresponding to the second biometric information among one or more first biometric information stored in the memory; and
transmitting payment information to mobile terminal that is a transmission source of the specified first biometric information.

2. The information processing method according to claim 1,
wherein the computer:
stores, in the memory, the first biometric information and terminal information for identifying the mobile terminal in association, the terminal information being transmitted with the first biometric information from the mobile terminal, and
transmits the payment information to the mobile terminal, based on the terminal information corresponding to the specified first biometric information.

3. The information processing method according to claim 1, the procedure further comprising:
deleting, when a predetermined time has elapsed after the first biometric information transmitted from the mobile terminal is stored in the memory, the first biometric information from the memory.

4. The information processing method according to claim 1, the procedure further comprising:
deleting, when a completion of processing of the payment information of the mobile terminal is detected, the first biometric information from the memory.

5. The information processing method according to claim 1, the procedure further comprising:
deleting, when the mobile terminal does not satisfy the condition of the position with respect to the computer, the biometric information from the memory.

6. An information processing system comprising:
a mobile terminal;
a payment terminal configured to communicate with the mobile terminal; and
a beacon configured to transmit, to the mobile terminal, service connection information of the payment terminal within a transmission range of the payment terminal, wherein
when the mobile terminal receives the service connection information from the beacon, the mobile terminal transmits first biometric information to the payment terminal,
when the payment terminal receives the first biometric information from the mobile terminal, the payment terminal stores the first biometric information in a memory, and
when second biometric information is captured, the payment terminal specifies first biometric information corresponding to the second biometric information among one or more first biometric information stored in the memory, and transmits payment information to mobile terminal that is a transmission source of the specified first biometric information.

7. The information processing system according to claim 6, wherein the
payment terminal includes the beacon.

8. An information processing apparatus comprising:
a memory; and
a processor coupled to the memory and configured to:
store, when first biometric information transmitted from a mobile terminal whose position with respect to the computer satisfy a condition is received, the first biometric information in the memory;
specify, when second biometric information is captured by the information processing apparatus, first biometric information corresponding to the second biometric information among one or more first biometric information stored in the memory; and
transmit payment information to mobile terminal that is a transmission source of the specified first biometric information.
